(19) United States
(12) Patent Application Publication
(10) Pub. No.: US 2003/0114575 A1
(43) Pub. Date: Jun. 19, 2003

(54) Fiber reinforced thermoplastic composition

(75) Inventor: Erich O. Teutsch, Richmond, MA (US)

Correspondence Address: William F. Mufatti, General Electric Company, One Plastics Avenue, Pittsfield, MA, 01201, US

(73) Assignee: GENERAL ELECTRIC COMPANY

(21) Appl. No.: 10/316,258

(22) Filed: Dec. 10, 2002

Related U.S. Application Data
(63) Continuation-in-part of application No. 09/648,659, filed on Aug. 25, 2000.

(51) Int. Cl. C08K 3/40; C08K 3/04; C08K 3/34; C08K 11/00

(52) U.S. Cl. 524/494; 524/495; 524/442

(57) ABSTRACT

A resin composition comprising of the reinforcing fibers a resin and a particular reinforcing fiber. The particular shape of the reinforcing fiber must be irregular in shape having a periodic irregularity of less than the average length of the fiber in the finished article. The periodic irregularity should occur at least twice in any given length of fiber. The resin is either a thermoplastic or a thermoset resin. The fiber has a modulus ether higher, essentially the same as or lower than the resin.

### CROSS-REFERENCE TO RELATED APPLICATIONS

This application claims rights of priority from U.S. patent application Ser. No. 09/648,659, filed Aug. 25, 2000 and U.S. Provisional Patent Application Serial No. 60/150,888, filed Aug. 26, 1999.

### BACKGROUND OF THE INVENTION

The present invention is directed to reinforced resin composition containing fibrous material.

### DESCRIPTION OF THE RELATED ART

Reinforcing fibers are incorporated with a thermoplastic polymer as an aid to the mechanical properties. In the manufacture of the reinforcing fibers, filaments are first formed through the use of various processes. The filaments are then gathered into a bundle known as a strand. In order to bind the filaments into a strand so that the strand can be handled, a binder or binding agent is applied to the glass filaments. Subsequently, the strand can be chopped into various lengths as desired. These are called chopped strands. Some of these binding agents are polymers such as polyvinyl acetate, particular polyester resins, starch, acrylic resins, melamine, polyvinyl chloride, polyethylene oxide, polyurethane, polyepoxide, or polyvinyl alcohol.

For thermoplastic aromatic polycarbonate and polyester resins, the reinforcing fibers enhance the mechanical properties of the resin. Usually, the coatings along with silane coupling agents are designed to give good adhesion of the fibers to the resin. Poor adhesion of fibers such as glass fibers to matrix resins tend to result in poor mechanical properties.

Accordingly, there is a need to provide improved fiber reinforced thermoplastic and thermoset materials.

### SUMMARY OF THE INVENTION

The basis of the invention is the entrapment of the reinforcing fibers by virtue of shape, either by inducing a spiral, wave or non-uniform diameter in the fiber. As long as the period of the irregularity is less than the length of the average reinforcing fiber in the finished part, the fiber should not be able to be pulled out of the plastic without deforming the plastic on a very small scale or without breaking.

The thermoplastic or thermoset resin compositions are useful as injection molding, extrusion, blow molding, compression molding or any melt processing techniques for plastic resins, and exhibit improved properties such as increased Izod impact strength, increased biaxial impact energy at maximum load, and increased tensile strength versus blends made with standard linear glass fibers even though they may have good adhesion to the matrix. This approach can also be advantageous in thermosets as well when used in such forms as sheet molding compounds (SMC), bulk molding compounds (BMC) and the like.

### BRIEF DESCRIPTION OF THE DRAWINGS

FIG. 1 illustrates a fiber having a non-uniform diameter, and

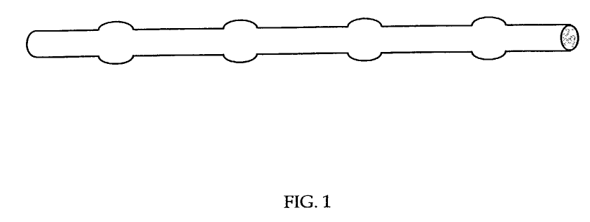

FIG. 2 illustrates a fiber having a wave configuration.

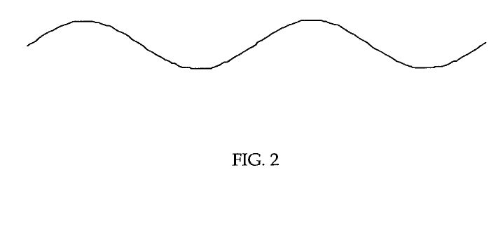

### DETAILED DESCRIPTION OF THE INVENTION

The effective bonding between reinforcing fibers such as chopped glass fibers and resin has always been less than optimal even though a great deal of effort has been expended to develop appropriate chemical bonding agents. A much simpler and totally effective method is based on mechanically trapping the fiber in the resin. To trap the fiber, the fiber must be irregularly shaped as defined hereafter or of non-uniform diameter with respect to length. If, therefore, the fibers can be formed with a periodic thickening and/or thinning or a sinusoidal wave (sine wave) the fiber will not be able to be drawn out of the resin substrate without actually breaking the fiber. The size and placement of the enlarged diameter or the amplitude and frequency of the wave formed fiber or such other irregularity must be periodic and can be controlled easily during manufacture with only minimal equipment changes or without interfering with feeding or compounding.

Theoretically any shape other than a straight rod is suitable as long as the irregularities are periodically placed frequently enough to occur at least twice in any given length of fiber in the finished part. In addition to the above mentioned periodic irregularities they can also take the form of a spirals, periodic flattening of the fiber, periodic twisting of a flattened fiber, etc. or any combination, thereof. An important feature is that the periodic irregularity can be induced without affecting the general process used for drawing the fibers. The periodic irregularity needs to be on the order of a fraction of the fiber diameter and a balance between effectiveness and processability needs to be maintained. For standard 16 μm diameter fiber a wave amplitude of 2-4 μm and or thickening i.e. changing the diameter of 2-4 μm every 50 μm in length or so (linear) should be sufficient to provide the mechanical interference to lock the fibers into the matrix. Inducing vibration of the fiber while pulling the fibers provides the periodic variation, which depends upon the rate of drawing the fibers, and frequency of the variation. The vibration may result in a cork screw by winding and varying the diameter by inducing motion in line with the fiber. Periodic motion (wave) perpendicular to the fiber will result in a wave; in line or in machine direction will result in thickening or thinning of diameter fiber. Also, it is preferred that the fiber have a high modulus substantially higher than the resin matrix, such fibers as glass, carbon or the like. However, lower modulus fibers may be used such as nylon, aramid, polyester and the like to improve impact and tensile strength. The modulus of the fiber may be essentially equal to or lower than the modulus of the resin. In some cases, the modulus of the resin may be higher than the modulus of the fiber depending on whether improved toughness or improved modulus is wanted.

The easiest procedure for inducing the irregularities would therefore be vibrating the fibers by mechanical or even sonic or ultra sonic means around the fiber axis or pulsing the fiber in the draw direction. Both methods are easily implemented and controlled and should not interfere with standard processing, chopping, feeding or packaging of the fiber.

This approach to locking reinforcing fibers into a matrix works for resins, including polyolefins which are notoriously difficult to lock in chemically and for processes including melt compounding of the thermoplastic and process such as lay-up and in continuous applications such as tape winding and pultrusion which may be used for either thermoplastic or thermoset resins.

The mechanical approach to bonding the fibers into the resin are applicable to all resins whereas chemical agents are resin specific, requiring the development of new agents for each resin and inventory of glass fiber for each type of resin; mechanically bonded fibers can be used in release grade formulations; mechanically bonded fibers will have little, if any, effect on cost; production of non-linear fibers will require only minor equipment modifications; and non-linear fibers should not interfere with feeding or dispersion during compounding.

The modified fibers should require very little change in fiber production equipment. The above mentioned fibers could be made easily by conventional equipment and should also be very effective.

In the practice of this invention, the fibers, such as glass fibers, may be first blended with the aromatic polycarbonate resin and polyester resin blend, for example, and then fed to an extruder, and the extrudate cut into pellets, or they may be separately fed to the feed hopper of an extruder. Generally, in the practice of this invention for preparing pellets of the composition set forth herein, the extruder is maintained at a temperature of approximately 480° F. to 550° F. The pellets so prepared when cutting the extrudate may be one-fourth inch, and may be longer or shorter or less. Such pellets contain finely divided uniformly dispersed glass fibers in the blend composition comprising aromatic carbonate polymer and polyester. The dispersed glass fibers are reduced in length as a result of the shearing action on the glass fibers in the extruder barrel during compounding and pelletizing. In addition, the amount of glass, for example, present in the composition can range anywhere from about 5 to about 50 weight percent based on the total weight of the thermoplastic blend composition, preferably from about 10 to about 30 percent by weight thereof. Generally, the fibers are any organic or inorganic reinforcing fiber and preferably a mineral fiber such as glass or silica

For compositions ultimately to be employed for electrical uses, it is preferred to use fibrous glass filaments comprised of lime-aluminum borosilicate glass that is relatively sodium free. This is known as “E” glass. However, other glass compositions are useful in the practice of the present invention, and all such glasses are contemplated as within the scope of the present invention. The filament diameters preferably range from about 3-20 micro meters (aim), but this is not critical to the present invention. In preparing the molding compositions of the present invention, it is convenient to use filamentous glass in the form of chopped strands of from about one-eighth to about 2 inches long. In articles molded from the compositions, herein disclosed, even shorter lengths will be encountered because, during compounding, considerable fragmentation may occur.

Thermoplastic polymers include polyester. Typical, polyester molding compositions include those comprising structural units of the following formula:

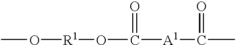

wherein each R1 is independently a divalent aliphatic, alicyclic or aromatic hydrocarbon or polyoxyalkylene radical, or mixtures thereof and each A1 is independently a divalent aliphatic, alicyclic or aromatic radical, or mixtures thereof. Examples of suitable polyesters containing the structure of the above formula are poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometimes desirable to have various concentrations of acid and hydroxyl end groups on the polyester, depending on the ultimate end-use of the composition.

The R1 radical may be, for example, a C2-10 alkylene radical, a C6-12 alicyclic radical, a C6-20 aromatic radical or a polyoxyalkylene radical in which the alkylene groups contain about 2-6 and most often 2 or 4 carbon atoms. The A1 radical in the above formula is most often p- or m-phenylene, a cycloaliphatic or a mixture thereof. This class of polyester includes the poly(alkylene terephthalates). Such polyesters are known in the art as illustrated by the following U.S. patents, which are incorporated herein by reference.

| | | | |
|---|---|---|---|
| 2,465,319 | 2,720,502 | 2,727,881 | 2,822,348 |
| 3,047,539 | 3,671,487 | 3,953,394 | 4,128,526 |

Examples of aromatic dicarboxylic acids represented by the dicarboxylated residue A1 are isophthalic or terephthalic acid, 1,2-di(p-carboxyphenyl)ethane, 4,4′-dicarboxydiphenyl ether, 4,4′ bisbenzoic acid and mixtures thereof. Acids containing fused rings can also be present, such as in 1,4-1,5- or 2,6-naphthalenedicarboxylic acids. The preferred dicarboxylic acids are terephthalic acid, isophthalic acid, naphthalene dicarboxylic acid, cyclohexane dicarboxylic acid or mixtures thereof.

The most preferred polyesters are poly(ethylene terephthalate) (“PET”), poly(1,4-butylene terephthalate) (“PBT”), poly(ethylene naphthanoate) (“PEN”), poly(butylene naphthanoate) (“PBN”), and (polypropylene terephthalate) (“PPT”), and mixtures thereof.

Also contemplated herein are the above polyesters with minor amounts, e.g., from about 0.5 to about 5 percent by weight, of units derived from aliphatic acid and/or aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

The preferred polyester resin used in this invention is poly(1,4-butylene terephthalate) resin and is obtained by polymerizing a glycol component at least 70 mol %, preferably at least 80 mol %, of which consists of tetramethylene glycol and an acid or ester component at least 70 mol %, preferably at least 80 mol %, of which consists of terephthalic acid, and polyester-forming derivatives therefore.

The polyesters used herein have an intrinsic viscosity of from about 0.4 to about 2.0 dl/g as measured in a 60:40 phenol/tetrachloroethane mixture or similar solvent at 23°-30° C. Preferably the intrinsic viscosity is 1.1 to 1.4 dl/g. VALOX® 315 polyester resin is particularly suitable for this invention.

Thermoplastic polycarbonate resins may be desirable used for composites of the present invention. Such polycarbonate resins are generally aromatic polycarbonate resins.

Typically these are prepared by reacting a dihydric phenol with a carbonate precursor, such as phosgene, a haloformate or a carbonate ester. Generally speaking, such carbonate polymers may be typified as possessing recurring structural units of the formula

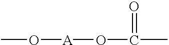

wherein A is a divalent aromatic radical of the dihydric phenol employed in the polymer producing reaction. The dihydric phenol which may be employed to provide such aromatic carbonate polymers are mononuclear or polynuclear aromatic compounds, containing as functional groups two hydroxy radicals, each of which is attached directly to a carbon atom of an aromatic nucleus. Typical dihydric phenols are: 2,2-bis(4-hydroxyphenyl) propane; hydroquinone; resorcinol; 2,2-bis(4-hydroxyphenyl) pentane; 2,4′-(dihydroxydiphenyl) methane; bis(2-hydroxyphenyl) methane; bis(4-hydroxyphenyl) methane; 1,1-bis(4-hydroxyphenyl)-3,3,5-trimethylcyclohexane; fluorenone bisphenol, 1,1-bis(4-hydroxyphenyl) ethane; 3,3-bis(4-hydroxyphenyl) pentane; 2,2′-dihydroxydiphenyl; 2,6-dihydroxynaphthalene; bis(4-hydroxydiphenyl)sulfone; bis(3,5-diethyl-4-hydroxyphenyl)sulfone; 2,2-bis(3,5-dibromo-4-hydroxyphenyl)propane; 2,2-bis(3,5-dimethyl-4-hydroxyphenyl)propane; 2,4′-dihydroxydiphenyl sulfone; 5′-chloro-2,4′-dihydroxydiphenyl sulfone; 4,4′-dihydroxydiphenyl ether; 4,4′-dihydroxy-3,3′-dichlorodiphenyl ether, and the like.

Other dihydric phenols which are also suitable for use in the preparation of the above polycarbonates are disclosed in U.S. Pat. Nos. 2,999,835; 3,038,365; 3,334,154; and 4,131,575, which are incorporated herein by reference.

These aromatic polycarbonates can be manufactured by known processes, such as, for example and as mentioned above, by reacting a dihydric phenol with a carbonate precursor, such as phosgene, in accordance with methods set forth in the above-cited literature and in U.S. Pat. No. 4,123,436, or by transesterification processes such as are disclosed in U.S. Pat. No. 3,153,008, as well as other processes known to those skilled in the art, which are also incorporated herein by reference.

It is also possible to employ two or more different dihydric phenols or a copolymer of a dihydric phenol with a glycol or with a hydroxy- or acid-terminated polyester or with a dibasic acid or hydroxy acid in the event a carbonate copolymer or interpolymer rather than a homopolymer is desired for use in the preparation of the polycarbonate mixtures of the invention. Polyarylates and polyester-carbonate resins or their blends can also be employed. Branched polycarbonates are also useful, such as are described in U.S. Pat. No. 4,001,184, incorporated herein by reference. Also, there can be utilized blends of linear polycarbonate and a branched polycarbonate. Moreover, blends of any of the above materials may be employed in the practice of this invention to provide the aromatic polycarbonate.

In any event, the preferred aromatic carbonate for use in the practice in the present invention is a homopolymer, e.g., a homopolymer derived from 2,2-bis(4-hydroxyphenyl)propane (bisphenol-A) and a carbonyl chloride, commercially available under the trademark LEXAN® from General Electric Company.

The instant polycarbonates are preferably high molecular weight aromatic carbonate polymers having an intrinsic viscosity, as determined in chloroform at 25° C. of from about 0.3 to about 1.5 dl/gm, preferably from about 0.45 to about 1.0 dl/gm. These polycarbonates may be branched or unbranched and generally will have a weight average molecular weight of from about 10,000 to about 200,000, preferably from about 20,000 to about 100,000 as measured by gel permeation chromatography.

The branched polycarbonates may be prepared by adding a branching agent during polymerization. These branching agents are well known and may comprise polyfunctioial organic compounds containing at least three functional groups which may be hydroxyl, carboxyl, carboxylic anhydride, haloformyl and mixtures thereof. Specific examples include trimellitic acid, trimellitic anhydride, trimellitic trichloride, tris-p-hydroxy phenyl ethane, isatin-bis-phenol, tris-phenol (1,3,5-tris((p-hydroxyphenyl)isopropyl)benzene), tris-phenol (4(4(1,1-bis(p-hydroxyphenyl)-ethyl)alpha, alpha-dimethyl benzyl)phenol), 4-chloroformyl phthalic anhydride, trimesic acid and benzophenone tetracarboxylic acid. The branching agent may be added at a level of about 0.05-2.0 weight percent. Branching agents and procedures for making branched polycarbonates are described in U.S. Pat. Nos. 3,635,895; 4,001,184; and 4,204,047 which are incorporated herein by reference.

All types of polycarbonate end groups are contemplated as being within the scope of the present invention.

Preferably the glass fibers are present at a level of from about 5 to about 50 percent by weight based on the total weight of the composition, and more preferably present at a level of from about 10 to about 30 percent by weight based on the total weight of the composition.

The thermoplastic resin composition may optionally contain impact modifiers such as a rubbery impact modifier. Suitable modifiers include core-shell polymers built up from a rubber-like core on which one or more shells have been grafted. The core typically consists substantially of an acrylate rubber or a butadiene rubber. One or more shells typically are grafted on the core. The shell preferably comprises a vinylaromatic compound and/or a vinylcyanide and/or an alkyl(meth)acrylate. The core and/or the shell(s) often comprise multi-functional compounds which may act as a cross-linking agent and/or as a grafting agent. These polymers are usually prepared in several stages. It is also contemplated that vinyl polymers may be the primary component of the resin to be reinforced.

Olefin-containing copolymers such as olefin acrylates and olefin diene terpolymers can also be used as impact modifiers in the present compositions. An example of an olefin acrylate copolymer impact modifier is ethylene ethylacrylate copolymer available from Union Carbide as DPD-6169. Other higher olefin monomers can be employed as copolymers with alkyl acrylates, for example, propylene and n-butyl acrylate. The olefin diene terpolymers are well known in the art and generally fall into the EPDM (ethylene propylene diene) family of terpolymers. Polyolefins such as polyethylene, polyethylene copolymers with alpha olefins are also of use in these compositions. It is also contemplated that the polyolefins may be the primary component of the resin to be reinforced. Other commonly available polyolefins include LLPE, HDPE, PP, copolymers thereof, LDPE, and vinyls such as PVC and CPVC.

Styrene-containing polymers can also be used as impact modifiers. Examples of such polymers are acrylonitrile-butadiene-styrene (ABS), acrylonitrile-butadiene-alpha-methylstyrene, styrene-butadiene, styrene butadiene styrene (SBS), styrene ethylene butylene styrene (SEBS), methacrylate-butadiene-styrene (MBS), and other high impact styrene-containing polymers. These impact modifiers may be the primary component of the resin to be reinforced.

The composition of this invention finds utility in preparing or forming articles by injection molding, extrusion, compression molding or blow molding, etc. wherein the articles have increased strength by employing the reinforcing fibers so described herein.

What is claimed:

1. A resin composition comprising in combination a resin and a particular shaped reinforcing fiber said composition having increased Izod impact strength, increased biaxial impact energy at maximum load and increased tensile strength compared to resin compositions containing a standard linear fiber wherein said particular fibers are irregular in shape, having a periodic irregularity of less than the average length of the fiber in the finished article and said resin being a thermoplastic resin or thermoset resin.

2. The composition of claim 1 wherein the periodic irregularity of the reinforcing fiber occurs at least twice in any given length of fiber.

3. The composition of claim 1 wherein the reinforcing fiber is a non-linear sinusoidal wave.

4. The composition of claim 1 wherein the reinforcing fiber is spiral in shape.

5. The composition of claim 1 wherein the reinforcing fiber is a twisted flattened fiber.

6. The composition of claim 1 wherein the reinforcing fiber is formed with a periodic thickening and thinning of the diameter.

7. The composition of claim 1 wherein the reinforcing fiber of about 16 μm in diameter has a wave amplitude of about 2-4 μm and a thickening of diameter of about 2-4 μm for about every 50 μm in length.

8. The composition of claim 1 wherein the reinforcing fiber cannot be withdrawn out of the resin substrate without substantial breakage of fibers.

9. The composition of claim 1 wherein the fiber has a high modulus which is substantially higher than the resin matrix.

10. The composition of claim 9 wherein the fiber is glass, carbon, mineral fibers and the like.

11. The composition of claim 10 wherein the reinforcing fibers are glass fibers and are present at a level of from about 5 to about 50 percent by weight based on the total weight of the composition.

12. The composition of claim 1 wherein the modulus of the fiber is essentially equal to or lower than the modulus of the resin matrix to improve impact or tensile strength on both.

13. The composition of claim 12 wherein the fiber is nylon, aramid, polyester and the like.

14. The composition of claim 1 wherein the modulus of the resin is higher than the modulus of the fiber to improve toughness or modulus or both.

15. The resin composition according of claim 1 wherein said resin is a thermoplastic resin selected from the group consisting of a polycarbonate, a polyester, a polyolefin, a polyamide, a vinyl containing polymer or mixtures thereof.

16. The composition of claim 15 wherein the polyester resin composition comprises structural units of the following formula: 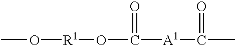
wherein each R1 is independently a divalent aliphatic, alicyclic or aromatic hydrocarbon or polyoxyalkylene radical, or mixtures thereof and each A1 is independently a divalent aliphatic, alicyclic or aromatic radical, or mixtures thereof.

17. The composition of claim 16 wherein said polyester resin is selected from the group consisting of poly(ethylene terephthalate), poly(1,4-butylene terephthalate), poly(ethylene naphthanoate), poly(butylene naphthanoate), and (polypropylene terephthalate), and mixtures thereof.
